(19) United States
(12) Patent Application Publication
(10) Pub. No.: US 2007/0197115 A1
(43) Pub. Date: Aug. 23, 2007

(54) Woven material and display device constructed therefrom

(75) Inventors: David A. Eves, Crawley (GB); Lucas J.F. Schlangen, 'S-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,485

(22) PCT Filed: Dec. 14, 2004
(86) PCT No.: PCT/IB04/52806

§ 371 Date: Jun. 15, 2006

(30) Foreign Application Priority Data
Dec. 20, 2003 (GB) 0329566.4

(51) Int. Cl. D03D 15/00; B32B 5/16

(52) U.S. Cl. 442/194; 442/209; 442/227

(57) ABSTRACT

Woven material comprises a first set of electrically conductive elements and a second set of hollow fibres, the hollow fibres containing electrophoretic material. The electrically conductive elements may be substantially perpendicular to the hollow fibres. A third set may also be present, for example, a set of insulated electrically conductive elements (as shown in FIG. 1), substantially parallel to the hollow fibres, or a set of electrically conductive elements, being contained within the hollow fibres, or another set of hollow fibres, also containing electrophoretic material, being substantially perpendicular to the original hollow fibres. A display device comprising the woven material is also described which further includes electrical connectors connecting to the electrically conductive elements and circuitry connected to the electrical connectors and driving the display device.

This invention relates to woven materials and to a display device constructed from such materials.

Traditionally display devices such as televisions and computer monitors are made from a cathode ray tube (CRT), which is a relatively heavy device with a glass tube on which an image is produced. More recently liquid crystal and LED displays have been developed, which are more lightweight then traditional CRT displays, but are also based upon a sheet of glass. It is a desire in the display field to produce a display that is more flexible, lightweight and robust than the glass tube or substrate widely used at present. Work is being carried out on LED displays with a plastic substrate, which have some improvement over known displays. Work is also being carried out on woven displays.

Such a woven display is found in U.S. Pat. No. 6,072,619, which discloses a light modulating device, which includes a first set of fibers and a second set of fibers being arranged to form a two dimensional array of junctions between fibers of the first set of fibers and fibers of the second set of fibers. Each of the fibers of the first and second sets of fibers includes a longitudinal conductive element, whereas fibers of at least one of the first and second sets of fibers, at least at the junctions, further include a coat of an electro -optically active substance being capable of reversibly changing its optical behaviour when subjected to an electric or magnetic flux or field. The woven display of this patent has a number of disadvantages, principally related to the need to coat either individual fibres or the woven fibres with the electro-optically active substance. This increases the complexity of the manufacture of the display and makes the finished display more complex and less robust than is ideal.

It is therefore an object of the present invention to improve upon the known art.

According to a first aspect of the present invention, there is provided woven material comprising a first set of electrically conductive elements and a second set of hollow fibres, the hollow fibres containing electrophoretic material.

Owing to this aspect of the invention, it is possible to provide a woven material for use as a display, which is easier to construct than known woven displays and as a finished material is robust and flexible while still maintaining good display qualities.

In a preferred embodiment the first set of electrically conductive elements is substantially perpendicular to the second set of hollow fibres. Cross weaves of the elements and fibres is also possible.

Advantageously, the woven material further comprises a third set of insulated electrically conductive elements, the third set of elements being substantially parallel to the second set of hollow fibres. Alternatively, the material may comprise a third set of electrically conductive elements, the third set of elements being contained within the second set of hollow fibres. In a third option, the woven material may further comprise a third set of hollow fibres, the hollow fibres containing electrophoretic material, the third set of hollow fibres being substantially perpendicular to the second set of hollow fibres.

Preferably, the electrophoretic material in the hollow fibres includes a suspension fluid (which could be a liquid or gas) containing coloured (white, black or any other colour) electrically charged species. The species may be particles or inverse micelles. This suspension fluid can be an isoparraffinic solvent and the charged particles may include a pigment. The suspension fluid may contain a neutral, uncharged dye.

According to a second aspect of the present invention, there is provided a display device comprising woven material as described above, electrical connectors connecting to the electrically conductive elements and circuitry connected to the electrical connectors and driving the display device.

Owing to this aspect of the invention it is possible to provide a display that has multi-dimensional flexibility, is relatively cheap and easy to produce, does not require clean conditions to produce and can be a small part of much bigger woven structure. This allows the easy production of a viable display device in such applications as clothing, furnishings and car interiors.

Embodiments of the invention will now be described, by way of example only, with reference to the accompanying drawings, in which:

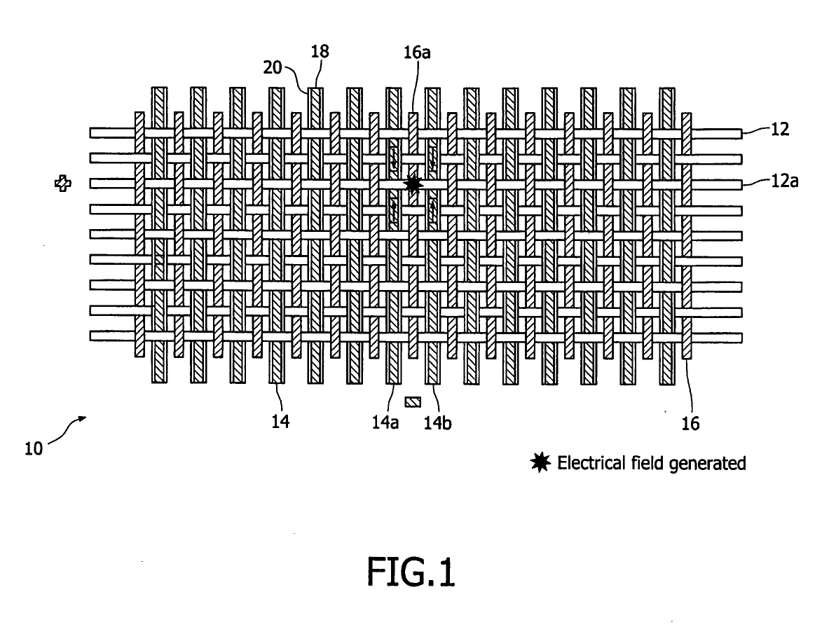

FIG. 1 is a schematic diagram of a first embodiment of a woven material,

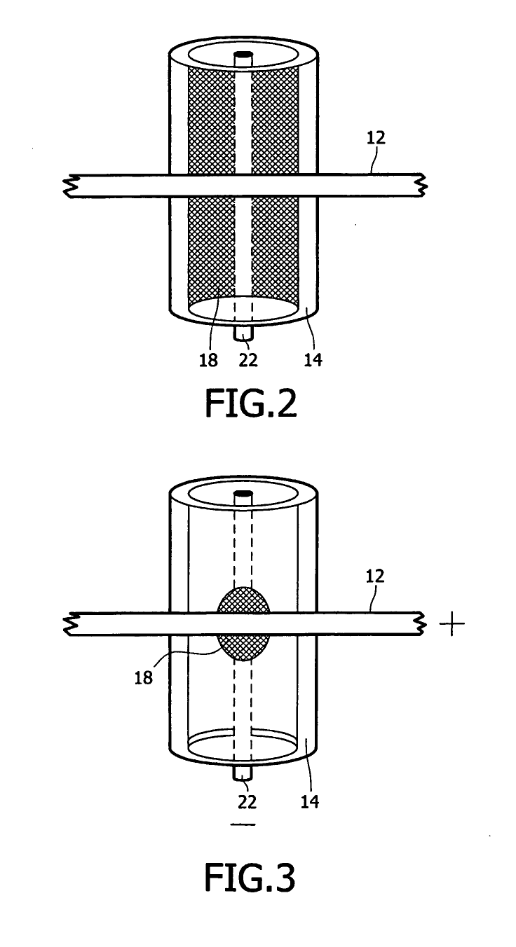

FIG. 2 is a schematic section of a small portion of a second embodiment of the woven material,

FIG. 3 is the schematic section shown in FIG. 2, but with an electrical field generated,

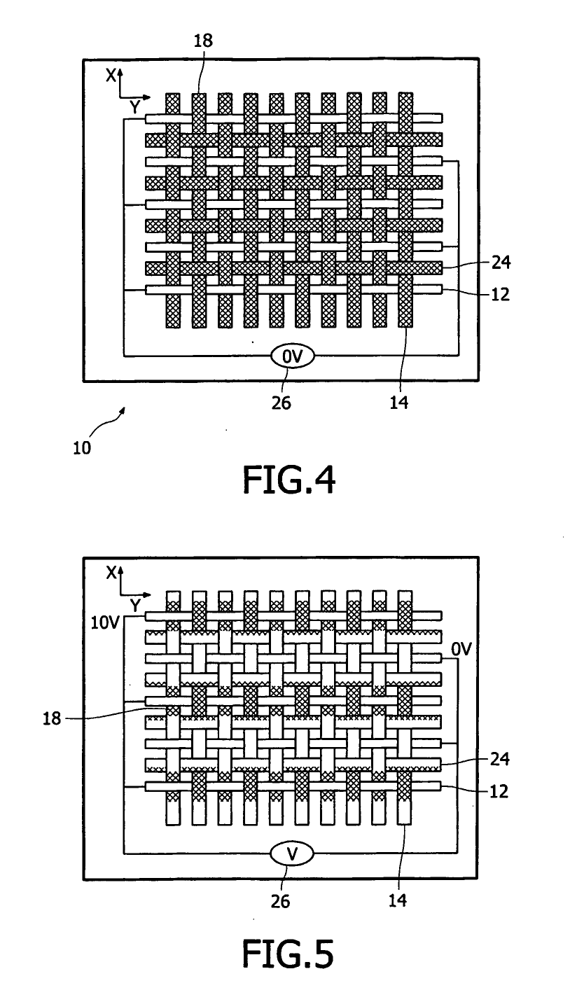

FIG. 4 is a schematic diagram of a third embodiment of the woven material,

FIG. 5 is the schematic diagram shown in FIG. 4, but with an electrical field generated, and

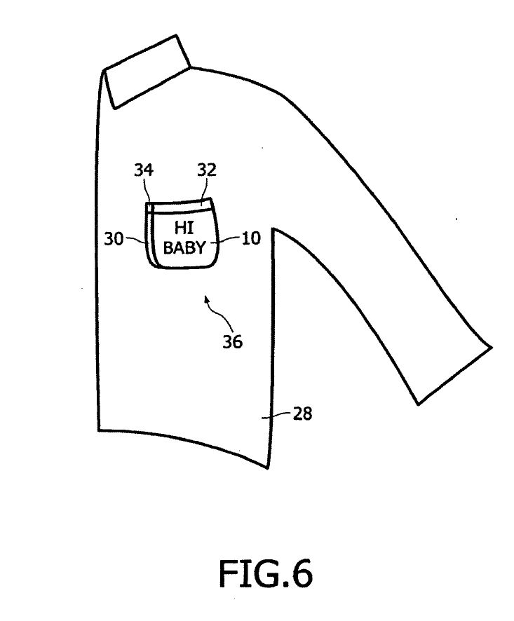

FIG. 6 is a schematic diagram of a portion of a garment incorporating a display device.

FIG. 1 shows a first embodiment of the woven material 10, which comprises a first set of electrically conductive elements 12, a second set of hollow fibres 14, the hollow fibres 14 containing electrophoretic material 18, and a third set of insulated electrically conductive elements 16, the third set of elements 16 being substantially parallel to the second set of hollow fibres 14. The first set of electrically conductive elements 12 is substantially perpendicular to the second set of hollow fibres 14.

The material 10 is of a woven construction and formed by weaving together the first set 12 of electrically conductive elements with the second set of hollow fibres 14 and also the insulated electrically conductive elements 16. By weaving together the elements the resulting form of the material 10 is that of a woven sheet.

The first set of electrically conductive elements 12 are made of copper fibre but may alternately be of aluminium or stainless steel fibre. The first set of electrically conductive elements 12 can be considered to be the weft yarn of the weave with each conductive element 12 having its major axis substantially in parallel with the other elements 12.

The third set of insulated electrically conductive elements 16 are formed of an electrically conductive core surrounded with an electrically insulting covering material. One such example is an electrically insulated copper fibre or aluminium or stainless steel fibre. Examples of the electrically insulating cover material include PVC or varnish. The third set of electrically conductive elements 16 can be considered to form the warp yarn of the weave with each conductive element 16 having its major axis substantially in parallel with the is other elements 16.

Due to the structure of the weave the major axes of the first set of electrically conductive elements 12 are arranged substantially perpendicularly to the major axes of the third set of insulated electrically conductive elements 14.

The second set of hollow fibres 14 also form the warp yarn of the weave such that each of the fibres 14 has its major axis substantially in parallel with other fibres 14 and also substantially in parallel with the insulated conductive elements 16. Each hollow fibre 14 is located between two adjacent insulated electrically conductive elements 16 so that adjacent warp yarns (fibres) of the weave are provided in the sequence of insulated conductive element 16 -hollow fibre 14- insulated conductive element 16- hollow fibre 14, and so on.

The hollow fibre 14 is formed of a wall 20 of generally annular cross-section to provide an inner surface that defines an internal volume. The internal volume is filled with electrophoretic material 18. The electrophoretic material 18 includes a suspension in the form of a fluid containing electrically charged particles within the fluid. In the present embodiment the suspension is an isoparraffinic solvent and the charged particles contain a pigment. The pigment and suspension fluid are chosen to be optically distinct to each other, for example of a different colour. In the present embodiment the solvent is clear and the pigment is opaque. For illustrative purposes the pigment may be a colour, for example blue.

During operation of the woven material as a display, an electric potential is applied to one or more members of the first set of electrically conductive elements 12 and one or members of the third set of insulated electrically conductive elements 16.

For illustrative purposes FIG. 1 shows an example situation where a constant electric potential is applied to the conductive element 12a of the first set and conductive elements 16a of the third set of insulated conductive elements. A positive electric potential is applied to the conductive element 12a and a negative potential is applied to the insulated conductive elements 16a.

This causes an electric field to be established between the conductive elements 12a and 16a which is strongest where they cross each other by virtue of the weave structure, with the crossing point denoted in the Figure by the star. Although elements cross each other at this location the electrical conductors of element 12a and 16a do not make direct electrical contact with each other because the electrically insulative covering material of the insulated conductive element 16a separates them.

Running parallel to and next to insulated conductive element 14a is hollow fibre 14a on one side and hollow fibre 14b on the other side. The field generated at the location denoted by the star is sufficiently strong that it influences the electrophoretic material 18 contained in the nearby hollow fibres 14a and 14b in the vicinity of location of the star, such as to locally alter the appearance of the hollow fibres 14a and 14b, denoted in FIG. 1 by the arrows showing the movement of the electrophoretic material 18 towards the star showing the location of the electrical field that has been generated.

The change of appearance results because the act of exposing the electrophoretic material 18 to an electric field, as occurs around region denoted by the star, has the result of causing electrically charged pigment within the fluid to migrate because the charged particles experience a force whilst in the electric field.

The perpendicular arrangement of the first and third set of electrically conductive elements permits row and column type addressing, as in standard passive display technology. By selectively applying a potential difference to an element of the first set 12 and third set 16 of conductive elements by selectively applying a potential difference across conductive elements 12 and 16, pixel type addressing can be obtained.

It will be noted that in the above example, that although application of a potential to elements 12a and 16a causes a concentration of a resultant electric field at the crossing point of those elements, the presence of the electric field extends to the immediate vicinity of the crossing point to affect the electrophoretic material 18 in nearby hollow fibres 14a and 14b. As will be seen from FIG. 1, the volume of electrophoretic material 18 affected by the field, shown schematically as four regions denoted by the arrows—and therefore the area of the display which undergoes a change of optical appearance—is larger than would be the case if electrophoretic material 18 were instead included in one or both conductive elements 12a and 16a. Furthermore, the optical effect produced by the electrophoretic material 18 is not restricted to the actual crossing point, with the advantage that the optical effect is not obscured from view by an overlying conductive element 12a or 16a of the weave. In more complicated weave structures (not shown) it is possible that the hollow fibres 14 could be substantially hidden from view with the movement of the electrophoretic material 18 being such that it flows from a hidden point in the woven fabric 10 to a visible point.

Owing to the fact that the addressing of a particular crossing point affects the electrophoretic material present all around that point, the pixel type addressing employed will need to be adapted to a display of this type. For example, a particular pattern in the order of addressing may be used to provide superior results, rather than the conventional passive addressing.

It is possible to select the electrophoretic material so that in the absence of an electric field, the pigment moves within the suspension slowly, with the result that once an image has been established on the display device, the image remains visible for some time. This offers the potential advantage of reducing power consumption and/or lower processing demands on the driving circuitry, especially if the display is being used to present static or slow motion images.

In an alternative arrangement of the woven material 10 of FIG. 1 (not shown), the plurality of hollow fibres 14 form part of the weft yarn (rather than the warp yarn of FIG. 1) of the weave such that each of the hollow fibres 14 has its major axis substantially in parallel with other elements 14 and also substantially in parallel with the electrically conductive elements 12. Each hollow fibre 14 is located between two adjacent electrically conductive elements 12 so that adjacent weft yarns (fibres) of the weave are provided in the sequence of conductive element 12- hollow fibre 14- conductive element 12- hollow fibre 14- conductive element 12- . . . and so forth.

FIGS. 2 and 3 illustrate a schematic section of a small portion of a second embodiment of the woven material 10, FIG. 3 being the same schematic section shown in FIG. 2, but with an electrical field generated. The woven material 10 still comprises a first set of electrically conductive elements 12 and a second set of hollow fibres 14, each hollow fibre containing electrophoretic material 18, but instead of the insulated electrical conductor 16 of FIG. 1, the woven material 10 further comprises a third set of electrically conductive elements 22, the third set of elements 22 being contained within the second set of hollow fibres 14.

The embodiment shown in FIG. 2 and 3 is easier to weave, as there is effectively one set of elements in each of the weft and warp yarns. The horizontal weft yarn is made up of the first set of electrically conductive elements 12 and the vertical warp yarn is made up of the second set of hollow fibres 14, which contain within them the electrophoretic material 18 and the third set of electrically conductive elements 22.

In operation, this embodiment has a number of advantages, principally that the electric field that is to be generated to act upon the local electrophoretic material 18 is much closer to the material 18 than in the embodiment of FIG. 1. This means that the power required for a given field needed to produce a movement in the electrophoretic material 18 is reduced.

In FIG. 2, no potential difference is present across the two elements 12 and 22, so that no electric field is generated and therefore the electrophoretic material 18 is dispersed in the hollow fibre 14 and is not acted upon by any field. In FIG. 3, a potential difference is applied across the electrically conductive elements 12 and 22, as shown by the +and −symbols in the Figure, and even though there is no electrical connection between the two elements 12 and 22, an electrical field is generated in the physical space between the two elements 12 and 22 (which space contains the hollow fibre 14 and the electrophoretic material 18). The electrical field that is generated acts upon the electrophoretic material 18 and causes the material 18 to move together into the mass 18 shown in FIG. 3. This mass 18 is effectively a single “pixel” which is created when the necessary potential difference is is applied across the conductive elements that overlap each other at that location. As in FIG. 1, with correct addressing of the “row” and “column” conductive elements 12 and 22, an image can be built up and the woven material 10 acts as a display device.

A third embodiment of the woven material 10 is shown in FIG. 4 and 5. FIG. 5 is the same schematic diagram that is shown in FIG. 4, but with an electrical field generated. The woven material comprises (as before) a first set of electrically conductive elements 12 and a second set of hollow fibres 14, the hollow fibres 14 containing electrophoretic material 18. In addition, the woven material 10 further comprises a third set of hollow fibres 24, the hollow fibres 24 also containing electrophoretic material 18, the third set of hollow fibres 24 being substantially perpendicular to the second set of hollow fibres 14. In effect, in this third embodiment, the sets of hollow fibres 14 and 24 containing the electrophoretic material 18 are present in both the weft and warp yarns of the woven material.

This embodiment of the woven material 10 is also of woven construction and has a set of hollow fibres 14 extending in a first direction. The major axes of the hollow fibres 14 of the set are substantially in parallel with each other. Also provided is a second set of hollow fibres 24 extending in a second direction. The major axes of the hollow fibres 24 of the set are substantially in parallel with each other. The set of hollow fibres 14 can be considered to be the warp yarn of the weave and the set of hollow fibres 24 can be considered to be the weft yarn of the weave. Thus, due to the structure of the weave the major axes of the set of hollow fibres 14 are arranged substantially perpendicularly to the major axes of the set of hollow fibres 24.

The hollow fibres of the two sets of fibres 14 and 24 are the same as the hollow fibres of the first and second embodiments described above. The woven material 10 is provided with a first set of electrically conductive elements 12 with their major axes substantially in parallel to each other and extending in the second direction. Therefore the first set of electrically conductive elements 12 are arranged substantially in parallel with the hollow fibres 24. The conductive elements 12 are connected to a power source 26, which in the material 10 of FIG. 4 is set at 0 volts and so is not producing a potential difference. This results in the electrophoretic material 18 in the sets of hollow fibres 14 and 24 maintaining an even spread throughout the hollow fibres 14 and 24. As shown in FIG. 4, the pigment of the electrophoretic material 18 in the hollow fibres 14 and 24 is evenly distributed, denoted by the even shading of those elements. The electrically conductive elements 12 are connected alternately to the positive and negative sides of the power source 26, as can be seen in FIG. 4.

FIG. 5 shows the woven material 10 of the third embodiment when a potential difference of 10 volts is applied by the power source 26. Those elements of the first set of electrically conductive elements 12 that are connected to the positive side of the power source 26 attract the electrophoretic material 18 contained within the hollow fibres 14 and 24 towards them. This results in an effective display being produced that consists of a number of lines of the electrophoretic material 18. The relatively simple display had the advantage over the first and second embodiments, in that a very simple power and control mechanism is required, because it is not necessary to address individual “pixels” in the woven material 10.

A variant of the embodiment of FIGS. 4 and 5 is possible in which the woven material has the first set of electrically conductive elements substantially parallel to the second set of hollow fibres, and the woven material further comprises a third set of inert fibres.

FIG. 6 is a schematic diagram of a portion of a garment 28 incorporating a display device 36. The display device 36 comprises the woven material 10 (which may be of any of the embodiments described above), electrical connectors 30 and 32 connecting to the electrically conductive elements (whichever sets are present) and circuitry 34 connected to the electrical connectors 30 and 32 and driving the display device 36. In this instance the display device 36 is being controlled to produce the display “HI BABY”.

1. Woven material comprising a first set of electrically conductive elements (12) and a second set of hollow fibres (14), the hollow fibres (14) containing electrophoretic material (18).

2. Woven material according to claim 1, wherein the first set of electrically conductive elements (12) is substantially perpendicular to the second set of hollow fibres (14).

3. Woven material according to claim 1, the woven material further comprising a third set of insulated electrically conductive elements (16).

4. Woven material according to claim 3, wherein the third set of elements (16) is substantially parallel to the second set of hollow fibres (14).

5. Woven material according to claim 1, the woven material further comprising a third set of electrically conductive elements (22).

6. Woven material according to claim 5, wherein the third set of elements (22) are contained within the second set of hollow fibres (14).

7. Woven material according to claim 1, the woven material further comprising a third set of hollow fibres (24), the hollow fibres (24) containing electrophoretic material (18).

8. Woven material according to claim 7, wherein the third set of hollow fibres (24) is substantially perpendicular to the second set of hollow fibres (14).

9. Woven material according to claim 1, wherein the first set of electrically conductive elements is substantially parallel to the second set of hollow fibres, and the woven material further comprises a third set of inert fibres.

10. Woven material according to claim 1, wherein the electrophoretic material (18) includes a suspension fluid containing coloured electrically charged species.

11. Woven material according to claim 10, wherein the coloured electrically charged species are particles.

12. Woven material according to claim 10, wherein the coloured electrically charged species are inverse micelles.

13. Woven material according to claim 11, wherein the suspension fluid is isoparraffinic solvent and the charged particles include a pigment.

14. A display device comprising woven material (10) according to claim 1, electrical connectors (30, 32) connecting to the electrically conductive elements (12; 12, 22) and circuitry (34) connected to the electrical connectors (30, 32) and driving the display device (36).
